(19) United States
(12) Patent Application Publication
(10) Pub. No.: US 2026/0239059 A1
(43) Pub. Date: Aug. 13, 2026

(54) APPARATUSES, METHODS AND COMPUTER PROGRAMS

(71) Applicant: Nokia Technologies Oy, Espoo (FI)

(72) Inventors: Ozgur Umut AKGUL, Espoo (FI); Shohreh AHVAR, Massy (FR); Shubhranshu SINGH, Munich (DE); Laurent GOIX, Massy (FR); Philippe GODIN, Massy (FR); Daniela LASELVA, Aalborg (DK)

(21) Appl. No.: 19/048,622

(22) Filed: Feb. 7, 2025

(51) Int. Cl. H04W 24/10; H04B 17/309; H04W 84/04

(52) U.S. Cl. CPC H04W 24/10; H04B 17/309; H04W 84/042

(57) ABSTRACT

A user equipment comprising at least one processor and at least one memory storing instructions that, when executed by the at least one processor, cause the user equipment at least to perform: receiving, from a first network, a configuration related to performance measurements of candidate networks for network sharing with the first network; while being served by the first network, detecting a node of at least one other network; measuring the at least one other network based on the configuration; and reporting at least one performance measurement of the least one other network to the first network.

### TECHNICAL FIELD

Various embodiments of this disclosure generally relate to apparatuses, methods, and computer programs, and—in particular, but not exclusively—to apparatuses, methods and computer programs for network sharing.

### BACKGROUND

A communication network can be seen as a facility that enables communications between two or more communication devices or provides communication devices access to a data network. A mobile or wireless communication network is one example of a communication network. A communication device may be provided with a service by an application server.

Such communication networks operate in according with standards such as those provided by 3GPP (Third Generation Partnership Project) or ETSI (European Telecommunications Standards Institute). Examples of standards include the so-called 5G (5th Generation) standards and 6G (6th Generation) standards promulgated by 3GPP.

### SUMMARY

Some embodiments of this disclosure will be described with respect to certain aspects. These aspects are not intended to indicate key or essential features of the embodiments of this disclosure, nor are they intended to be used to limit the scope of thereof. Other features, aspects, and elements will be readily apparent to a person skilled in the art in view of this disclosure.

According to a first aspect, there is provided a user equipment comprising at least one processor and at least one memory storing instructions that, when executed by the at least one processor, cause the user equipment at least to perform: receiving, from a first network, a configuration related to performance measurements of candidate networks for network sharing with the first network; while being served by the first network, detecting a node of at least one other network; measuring the at least one other network based on the configuration; and reporting at least one performance measurement of the least one other network to the first network.

According to a second aspect, there is provided a method performed by a user equipment, the method comprising: receiving, from a first network, a configuration related to performance measurements of candidate networks for network sharing with the first network; while being served by the first network, detecting a node of at least one other network; measuring the at least one other network based on the configuration; and reporting at least one performance measurement of the least one other network to the first network.

According to a third aspect, there is provided a computer program product for receiving, from a first network, a configuration related to performance measurements of candidate networks for network sharing with the first network; while being served by the first network, detecting a node of at least one other network; measuring the at least one other network based on the configuration; and reporting at least one performance measurement of the least one other network to the first network.

According to a fourth aspect, there is provided a computer program product embodied on a distribution medium readable by a computer and comprising program instructions which, when loaded into an apparatus, execute a method comprising receiving, from a first network, a configuration related to performance measurements of candidate networks for network sharing with the first network; while being served by the first network, detecting a node of at least one other network; measuring the at least one other network based on the configuration; and reporting at least one performance measurement of the least one other network to the first network.

According to a fifth aspect, there is provided an apparatus comprising means for performing: receiving, from a first network, a configuration related to performance measurements of candidate networks for network sharing with the first network; while being served by the first network, detecting a node of at least one other network; measuring the at least one other network based on the configuration; and reporting at least one performance measurement of the least one other network to the first network.

According to a sixth aspect, there is provided apparatus of a first network, the apparatus comprising at least one processor and at least one memory storing instructions that, when executed by the at least one processor, cause the apparatus at least to perform: receiving network sharing information comprising at least one of: an indication from a second network that the second network has capacity for network sharing with the first network; or a report from a user equipment served by the first network, the report comprising radio-related information of at least one other network, the at least one other network including the second network; retrieving, from a network function, a network sharing policy, and creating a network sharing request for the second network based at least on the network sharing policy and network sharing information

According to a seventh aspect, there is provided a method comprising: receiving network sharing information comprising at least one of: an indication from a second network that the second network has capacity for network sharing with a first network; or a report from a user equipment served by the first network, the report comprising radio-related information of at least one other network, the at least one other network including the second network; retrieving, from a network function, a network sharing policy, and creating a network sharing request for the second network based at least on the network sharing policy and network sharing information.

According to an eighth aspect, there is provided a computer program product for: receiving network sharing information comprising at least one of: an indication from a second network that the second network has capacity for network sharing with a first network; or a report from a user equipment served by the first network, the report comprising radio-related information of at least one other network, the at least one other network including the second network; retrieving, from a network function, a network sharing policy, and creating a network sharing request for the second network based at least on the network sharing policy and network sharing information.

According to a ninth aspect, there is provided a computer program product embodied on a distribution medium readable by a computer and comprising program instructions which, when loaded into an apparatus, execute a method comprising receiving network sharing information comprising at least one of: an indication from a second network that the second network has capacity for network sharing with a first network; or a report from a user equipment served by the first network, the report comprising radio-related information of at least one other network, the at least one other network including the second network; retrieving, from a network function, a network sharing policy, and creating a network sharing request for the second network based at least on the network sharing policy and network sharing information.

According to a tenth aspect, there is provided an apparatus comprising means for performing: receiving network sharing information comprising at least one of: an indication from a second network that the second network has capacity for network sharing with a first network; or a report from a user equipment served by the first network, the report comprising radio-related information of at least one other network, the at least one other network including the second network; retrieving, from a network function, a network sharing policy, and creating a network sharing request for the second network based at least on the network sharing policy and network sharing information.

According to an eleventh aspect, there is provided an apparatus of a first network, the apparatus comprising at least one processor and at least one memory storing instructions that, when executed by the at least one processor, cause the apparatus at least to perform: receiving network sharing information comprising at least one of: an indication from at least one other network that the at least one other network has capacity for network sharing with the first network; or a report from a user equipment served by the first network, the report comprising a signal strength of the at least one other network; creating a network sharing policy for the first network and the at least one other network based on the sharing information.

According to a twelfth aspect, there is provided a method comprising: receiving network sharing information comprising at least one of: an indication from at least one other network that the at least one other network has capacity for network sharing with a first network; or a report from a user equipment served by the first network, the report comprising a signal strength of the at least one other network; creating a network sharing policy for the first network and the at least one other network based on the sharing information.

According to a thirteenth aspect, there is provided a computer program product for receiving network sharing information comprising at least one of: an indication from at least one other network that the at least one other network has capacity for network sharing with a first network; or a report from a user equipment served by the first network, the report comprising a signal strength of the at least one other network; creating a network sharing policy for the first network and the at least one other network based on the sharing information.

According to a fourteenth aspect, there is provided a computer program product embodied on a distribution medium readable by a computer and comprising program instructions which, when loaded into an apparatus, execute a method comprising receiving network sharing information comprising at least one of: an indication from at least one other network that the at least one other network has capacity for network sharing with a first network; or a report from a user equipment served by the first network, the report comprising a signal strength of the at least one other network; creating a network sharing policy for the first network and the at least one other network based on the sharing information.

According to a fifteenth aspect, there is provided an apparatus comprising means for performing: receiving network sharing information comprising at least one of: an indication from at least one other network that the at least one other network has capacity for network sharing with a first network; or a report from a user equipment served by the first network, the report comprising a signal strength of the at least one other network; creating a network sharing policy for the first network and the at least one other network based on the sharing information.

According to a sixteenth aspect, there is provided an apparatus of a second network, the apparatus comprising at least one processor and at least one memory storing instructions that, when executed by the at least one processor, cause the apparatus at least to perform: sending, to a network node of a first network, an indication that second network has capacity for network sharing with the first network; and receiving, from the network node of the first network, a request for network sharing with the second network, wherein the request comprises information indicative of a reason for sharing.

According to a seventeenth aspect, there is provided a method comprising: sending, to a network node of a first network, an indication that second network has capacity for network sharing with the first network; and receiving, from the network node of the first network, a request for network sharing with the second network, wherein the request comprises information indicative of a reason for sharing.

According to an eighteenth aspect, there is provided a computer program product for sending, to a network node of a first network, an indication that second network has capacity for network sharing with the first network; and receiving, from the network node of the first network, a request for network sharing with the second network, wherein the request comprises information indicative of a reason for sharing.

According to a nineteenth aspect, there is provided a computer program product embodied on a distribution medium readable by a computer and comprising program instructions which, when loaded into an apparatus, execute a method comprising sending, to a network node of a first network, an indication that second network has capacity for network sharing with the first network; and receiving, from the network node of the first network, a request for network sharing with the second network, wherein the request comprises information indicative of a reason for sharing.

According to a twentieth aspect, there is provided an apparatus comprising means for performing: sending, to a network node of a first network, an indication that second network has capacity for network sharing with the first network; and receiving, from the network node of the first network, a request for network sharing with the second network, wherein the request comprises information indicative of a reason for sharing.

According to a twenty first aspect, there is provided a user equipment comprising at least one processor and at least one memory storing instructions that, when executed by the at least one processor, cause the user equipment at least to perform: while being registered to a first network and being served by a second network, wherein the first network and second network use network sharing, receiving, from the second network, a configuration to perform measurements of the second network related to network sharing performance; performing at least one measurement of the second network; and sending a measurement report including the at least one measurement to a network node.

According to a twenty second aspect, there is provided a method performed by a user equipment, the method comprising: while being registered to a first network and being served by a second network, wherein the first network and second network use network sharing, receiving, from the second network, a configuration to perform measurements of the second network related to network sharing performance; performing at least one measurement of the second network; and sending a measurement report including the at least one measurement to a network node.

According to a twenty third aspect, there is provided a computer program product for: while being registered to a first network and being served by a second network, wherein the first network and second network use network sharing, receiving, from the second network, a configuration to perform measurements of the second network related to network sharing performance; performing at least one measurement of the second network; and sending a measurement report including the at least one measurement to a network node.

According to a twenty fourth aspect, there is provided a computer program product embodied on a distribution medium readable by a computer and comprising program instructions which, when loaded into an apparatus, execute a method comprising: while being registered to a first network and being served by a second network, wherein the first network and second network use network sharing, receiving, from the second network, a configuration to perform measurements of the second network related to network sharing performance; performing at least one measurement of the second network; and sending a measurement report including the at least one measurement to a network node.

According to a twenty fifth aspect, there is provided an apparatus comprising means for performing: while being registered to a first network and being served by a second network, wherein the first network and second network use network sharing, receiving, from the second network, a configuration to perform measurements of the second network related to network sharing performance; performing at least one measurement of the second network; and sending a measurement report including the at least one measurement to a network node.

According to a twenty sixth aspect, there is provided an apparatus of a first network comprising at least one processor and at least one memory storing instructions that, when executed by the at least one processor, cause the apparatus at least to perform: initiating network sharing of a first network and a second network, such that the second network serves a user equipment while the user equipment is registered to the first network; sending, to a user equipment a request to perform measurements of the second network; and receiving, from the user equipment, the measurements of the first network

According to a twenty seventh aspect, there is provided a method comprising: initiating network sharing of a first network and a second network, such that the second network serves a user equipment while the user equipment is registered to the first network; sending, to a user equipment a request to perform measurements of the second network; and receiving, from the user equipment, the measurements of the first network.

According to a twenty eighth aspect, there is provided a computer program product for: initiating network sharing of a first network and a second network, such that the second network serves a user equipment while the user equipment is registered to the first network; sending, to a user equipment a request to perform measurements of the second network; and receiving, from the user equipment, the measurements of the first network.

According to a twenty nineth aspect, there is provided a computer program product embodied on a distribution medium readable by a computer and comprising program instructions which, when loaded into an apparatus, execute a method comprising: initiating network sharing of a first network and a second network, such that the second network serves a user equipment while the user equipment is registered to the first network; sending, to a user equipment a request to perform measurements of the second network; and receiving, from the user equipment, the measurements of the first network.

According to a thirtieth aspect, there is provided an apparatus comprising means for performing: initiating network sharing of a first network and a second network, such that the second network serves a user equipment while the user equipment is registered to the first network; sending, to a user equipment a request to perform measurements of the second network; and receiving, from the user equipment, the measurements of the first network.

According to some aspects, there is provided the subject matter of the independent claims. Some further aspects are defined in the dependent claims. The embodiments that do not fall under the scope of the claims are to be interpreted as examples useful for understanding the disclosure.

### BRIEF DESCRIPTION OF THE DRAWINGS

Some embodiments will now be described, by way of non-limiting and illustrative example only, with reference to the Figures, in which:

FIG. 1 shows an example of a communication network to which examples disclosed herein may be applied;

FIG. 2 shows an example of a method for dynamic network sharing according to some embodiments;

FIG. 3 shows a second example of a method for dynamic network sharking from the perspective of a donor MNO according to some embodiments;

FIG. 4 shows an example of a negotiation process according to some embodiments;

FIG. 5 shows an example of dynamic network sharing policy creation or update according to some embodiments;

FIG. 6 shows an example in which a UE may perform measurements according to some embodiments;

FIG. 7 shows an example of a method according to some embodiments;

FIG. 8 shows an example of a method according to some embodiments;

FIG. 9 shows an example of a method according to some embodiments;

FIG. 10 shows an example of a method according to some embodiments;

FIG. 11 shows an example of a method according to some embodiments;

FIG. 12 shows an example of a method according to some embodiments; and

FIG. 13 shows an example of an apparatus according to some embodiments.

### DETAILED DESCRIPTION

The following embodiments are provided by way of non-limiting and illustrative example. Although this disclosure may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments (whether or not explicitly described).

It shall be understood that although the terms “first,” “second” and the like may be used herein to describe various elements, these elements should not be limited by these terms. These terms are merely used to distinguish one element from another.

As used herein, the phrases “at least one of A or B”, “at least one of A and B”, and “A and/or B” means (A), (B), or (A and B). As used herein, the phrase “A, B, and/or C” means (A), (B), (C), (A and B), (A and C), (B and C), or (A, B, and C).

As used herein, the term “or” refers to a non-exclusive “or” unless otherwise indicated (e.g., use of “or else” or “or in the alternative”).

As used herein, and unless stated explicitly, performing a respective feature, step, or functionality “in response to A” does not indicate that the respective feature, step, or functionality is performed immediately after “A” occurs as one or more intervening features, steps, or functionalities may be performed (at least in part) between an occurrence of the respective feature, step, or function and “A”. Analogously, performing a respective feature, step, or functionality “based on A” does not indicate that the respective feature, step, or functionality is performed solely based on “A” as the respective feature, step, or functionality may be further based on one or more other features, steps, or functionalities in addition to “A”.

Embodiments described herein may be implemented in a communication network, such as any of the following radio access technologies (RATs): Worldwide Interoperability for Micro-wave Access (WiMAX), Global System for Mobile communications (GSM, 2G), GSM EDGE radio access Network (GERAN), General Packet Radio Service (GPRS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future RAT such as 6G. Moreover, communication within the communication network may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), and/or Discrete Fourier Transform spread OFDM (DFT-s-OFDM).

As used herein, the term “network device” or “network node” refers to a node in a communication network via which user equipment may access the network and/or which is capable of controlling radio communication and managing radio resources within a cell. The network node or network device may be referred to as a base station (BS), an access point (AP) or an access node. The network device may be, depending on the applied technology, for example, a node B (NodeB or NB), an evolved NodeB (eNodeB or eNB), an NR NB (also referred to as a gNB), a Remote Radio Unit (RRU), a radio head (RH), a remote radio head (RRH), a relay, an Integrated Access and Backhaul (IAB) node, a low power node, a non-terrestrial network (NTN) or non-ground network device such as a satellite network device, a low earth orbit (LEO) satellite and a geosynchronous earth orbit (GEO) satellite, or an aircraft network device.

Moreover, in connection of split radio access network (RAN), the network device may refer to a centralised unit (CU) of a base station and/or a distributed unit (DU) of a base station. An interface between CU and DU may be referred to as an F1 interface in NR. In the split RAN architecture, node operations may be carried out, at least partly, in the central/centralized unit, CU, (e.g. server, host or node) operationally coupled to the DU, (e.g. a radio head/node). One CU may control one or more DUs, acting at least as transmit/receive (Tx/Rx) nodes. In some embodiments, the DUs may comprise e.g. a radio link control (RLC), medium access control (MAC) layer and a physical (PHY) layer, whereas the CU may comprise the layers above RLC layer, such as a packet data convergence protocol (PDCP) layer, a radio resource control (RRC) and an internet protocol (IP) layer. Other functional splits are possible too. In practice, any processing task may be performed in either the CU or the DU and the boundary where the responsibility is shifted between the CU and the DU may depend on the applied implementation.

The term “terminal device” refers to any end device that may be capable of wireless communication. By way of non-limiting and illustrative example, a terminal device may be referred to as a communication device, user equipment (UE), a Subscriber Station (SS), or a Mobile Station (MS). The terminal device may be implemented as or included in a mobile phone, a cellular phone, a smart phone, voice over IP (VOIP) phones, wireless local loop phones a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, USB dongles, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

A term “resource”, as used herein, may refer to radio resources in time domain, in frequency domain, in space domain, and/or in code domain. Some examples of resources include e.g. a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources.

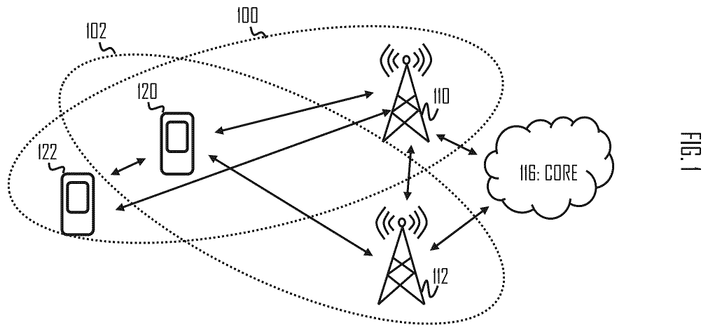

FIG. 1 illustrates an example of a communication network to which examples disclosed herein may be applied. The communication network or a cellular communication network may comprise a network node 110 configured to provide one or more cells, such as cell 100, and a network node 112 configured to provide one or more other cells, such as cell 102. Each cell may be, e.g., a macro cell, a micro cell, femto, or a pico cell, for example. The cell may define a coverage area or a service area of the corresponding node.

The network node 110 may provide a user equipment (UE) 120 (one or more UEs) with wireless access to the communication network. The wireless access may comprise downlink (DL) communication from the network node to the UE 120 and uplink (UL) communication from the UE 120 to the network node. Examples of uplink channels comprise physical uplink control channel (PUCCH) for transmitting control information and physical uplink shared channel (PUSCH) for transmitting data towards the network. Examples of downlink channels comprise physical downlink control channel (PDCCH) for transmitting control information and physical downlink shared channel (PDSCH) for transmitting data towards the user equipment.

There may be a plurality of UEs 120, 122 in the system. Each of the plurality of UEs 120, 122 may be served by the same or by different network nodes 110, 112. UE may be configured with dual connectivity (DC), wherein the UE, e.g. UE 120, may be connected to multiple network nodes 110, 112. The UEs 120, 122 may communicate with each other, in case device-to-device (D2D) communication interface is established between them via a so-called “sidelink” (SL). Such D2D communications may be referred to as machine-to-machine, peer-to-peer (P2P) communications, or vehicle-to-vehicle (V2V), for example.

In the case of multiple network nodes in the communication network, the network nodes may be connected to each other via an interface. LTE specifications refer to such an interface as “X2” interface. An interface between an LTE node and a 5G node, or between two 5G nodes may be referred to as an Xn interface.

The network nodes 110 and 112 may be further connected via another interface to a core network 116 of the communication network.

For example, LTE specifications specify the core network as an evolved packet core (EPC), and the core network may comprise e.g. a mobility management entity (MME) and a gateway node. The MME may handle mobility of terminal devices in a tracking area encompassing a plurality of cells and handle signalling connections between the terminal devices and the core network. The gateway node may handle data routing in the core network and to/from the terminal devices.

For example, 5G specifications specify the core network as a 5G core (5GC). The 5G core may comprise e.g. an access and mobility management function (AMF) and a user plane function/gateway (UPF) and other functions. The AMF may handle termination of non-access stratum (NAS) signalling, NAS ciphering & integrity protection, registration management, connection management, mobility management, access authentication and authorization, security context management. The UPF node may support packet routing and forwarding, packet inspection and quality of service (QoS) handling, for example.

Network sharing can be useful in certain situations where there might be a network outage, for example during a natural disaster or during a major event.

Due to the wide the wide geographical footprint of mobile communication networks, it has become the primary source of communication during the humanitarian efforts in a major disaster. It is important that the mobile communication networks are resilient and able to recover quickly during major disasters.

The Global System for Mobile Communications (GSMA) Disaster Response Program Report outlines the key aspects of disaster policies as:
Early Warning Systems and Preparedness;
Improved ability to provide essential services to customers;
Improved ability to support the work of the humanitarian community;
Reduced infrastructural damage to physical network architecture in a disaster;
Reduced failure of mobile networks in a disaster; and
Improved business continuity and revenue protection.

The disaster scenarios usually lead to an increased traffic volume, loss of infrastructure and different data prioritization mechanisms. The current solution is utilizing the disaster roaming (defined by 3GPP as Minimization of service interruption (MINT)), where a UE can access any of the available Public Land Mobiles Network(s) PLMN(s) regardless of the UE's operator to get a basic communication service. In order for disaster roaming to be activated, governmental entities need to declare the impacted area as the disaster area. MINT does not cover the cases where there is no declared public disaster. MINT also does not cover a situation where there is no public disaster but one or more of the operators are affected, e.g., due to local power outage, local fires, collapsed infrastructure that affects the one or more operators. Furthermore, MINT requires MINT-compliant UEs which exclude part of the user base.

Some examples described herein consider a network sharing concept for disaster roaming where the MNOs have agreements, which can guide UEs on the specific PLMNs they should choose in case of a disaster. 3GPP TS 22.261 V20 has defined service requirements to address disaster via “indirect network sharing”, a technique introduced in TS 23.501 V19 which can simplify the agreements between MNOs leveraging interactions at core network level.

Network sharing solutions typically rely on well-defined agreements and fixed resources (i.e., defined by a percentage (%), of their network resources to be allocated to network sharing capabilities provided to other MNOs). However, this type of reservationist solutions is not suitable to accommodate the dynamic needs related to network resources availability, uses, energy situations and so on, including also in case of the disaster scenario.

Some examples described herein related to “dynamic network sharing” which can allow, enable or otherwise facilitate optimal network resource use and also extend disaster roaming (disaster roaming is previously presented in 3GPP TS 23.122 V19.0.0). Dynamic sharing can decide to use resource shares operators dynamically and can therefore exploit more of the network sharing concept. Some examples relate to an advertisement and negotiation method for dynamic network sharing that allows, enables, or otherwise facilitates one or more of collection, negotiation and maintenance of all the necessary information to determine if the sharing is acceptable and under which conditions.

Examples described herein can be used for energy efficiency, load balancing, public safety and/or Quality of Service (QoS)/Quality of Experience (QoE) improvement.

For energy efficiency, a beneficiary node (a node that benefits from a service from another node) and a donor node (a node that provides a service to a UE) can have their PLMNs and CN at a given geographical area (which may be partially overlapping). There may be a decreased traffic load (e.g., due to the time of day, etc.). The beneficiary Mobile Network Operator (MNO) may offload one or more UEs connects to its PLMN and turn off the PLMN in the given area in order to be more energy efficient.

For load balancing, a donor node has unused resources while the beneficiary node has higher traffic than it can serve (e.g., due to a special event, a match or concert). The beneficiary node may move some of the UEs to the donor's network in order to maintain service continuity.

For public safety, there may be a case where a governmental agency (e.g., acting as a Mobile Virtual Network Operator (VMNO)) requires resources in a specific geographical area for a given period of time.

QoS/QoE improvement may be achieved where a beneficiary PLMN has agreements with neutral hosts or other 3rd party network providers (e.g., shop, malls, etc.) which can provide temporarily a better network coverage than the PLMN itself, e.g.: in indoor contexts. The PLMN may thus decide to trigger such sharing whenever a sufficient number of its UEs are collocated under the coverage of such providers, as long as they remain there. As the beneficiary PLMN may be charged additionally for this coverage service by the provider, it may want to deactivate network sharing as soon as a threshold is reached (e.g., none of its UEs are camping under that network). The beneficiary PLMN may provide this functionality for an extra fee to its own subscribers to authorize them to benefit from this service.

A decision to trigger dynamic network sharing can be taken by a base station (e.g., gNB) or by a Dynamic Network Sharing Function (DyNS) function autonomously. In some examples, the request may be triggered without previous knowledge of the other operator's gNBs (aka target gNBs). In some examples the DyNS to initiate this procedure with no prior involvement of gNBs. The release of dynamic (e.g., temporary) network sharing can be initiated either by the source or the target network. The Dynamic Network Sharing Function (DyNSF) may be responsible for the inter-MNO interactions and setting the sharing configurations intra-MNO.

Some examples are directed towards discovery of candidate MNO(s) for network sharing. In a geographical region, there is often available coverage from more than one MNO. However, not all of the MNOs may be a sharing candidate or preferred sharing candidate due to:
(1) the services that they provide in the given region,
(2) the type of energy (e.g., renewable, non-renewable, etc.) that they are using in their gNB,
(3) the degree of flexibility/the type of sharing that they support,
(4) their charging mechanisms, and/or
(5) special inter-MNO/inter-service provider agreements.

After discovering sharing MNO candidates (either as a future beneficiary or donor), more understanding on the surrounding actors and the sharing conditions can be determined in some examples. Metrics can be exchanged for network sharing decisions. The sharing decision can be performed using one or more metrics determined within the donor or beneficiary MNO side to evaluate the value of sharing. The conditions for a donor MNO to share its resources or the beneficiary MNO conditions and requirements often vary with time and location. Additionally:
(1) the available resources might be in an undesirable portion of the spectrum,
(2) the available services at the donor side may not cover the services provided (and thus potentially requested) by the beneficiary node, and/or
(3) one of the partners (beneficiary or donor) might be an undesired sharing partner for that particular region or service (due to competitive reasons).

Some examples also provide a method for inter-MNO negotiation method. Further examples relate to evaluating sharing partners and creating/updating policies, for example by making measurements to prove whether a UE was correctly served by this partner (to charge the UE and pay back the donor).

Examples described herein may relate to the following cases/scenarios:
1) Declared public disaster—public warning system labels the event as a disaster and informs the MNOs in the region (e.g., tsunami, earthquake, terror attack etc.);
2) Undeclared disaster—the disaster affects a subset of the MNOs with different severity levels. The public agency does not declare event as a disaster (fire, collapsed building etc.);
3) Temporary Network Sharing for energy efficiency/saving purposes—such as an MNO using the shared resources of another MNO to turn off its own gNB at low load;
4) Network sharing with Business drivers (e.g., providing coverage to a new region, minimizing the TCO per MNO, extending coverage; and/or
5) Network sharing with flexible network resource management-sharing during peak demand

Some examples described herein provide a method for determination of candidate donor PLMN(s) for RAN sharing for a beneficiary PLMN in a given area. This can be performed using UE measurements on available PLMNs in a certain geographic area and during a certain time.

Some examples relate to sharing policies regarding candidate PLMNs. This may include dynamic network sharing to allow, enable, or otherwise facilitate MNOs to negotiate sharing conditions. This may also include evaluation of the quality served to beneficiary UEs for enforcement of the committed sharing policy between the donor MNO and the beneficiary MNO.

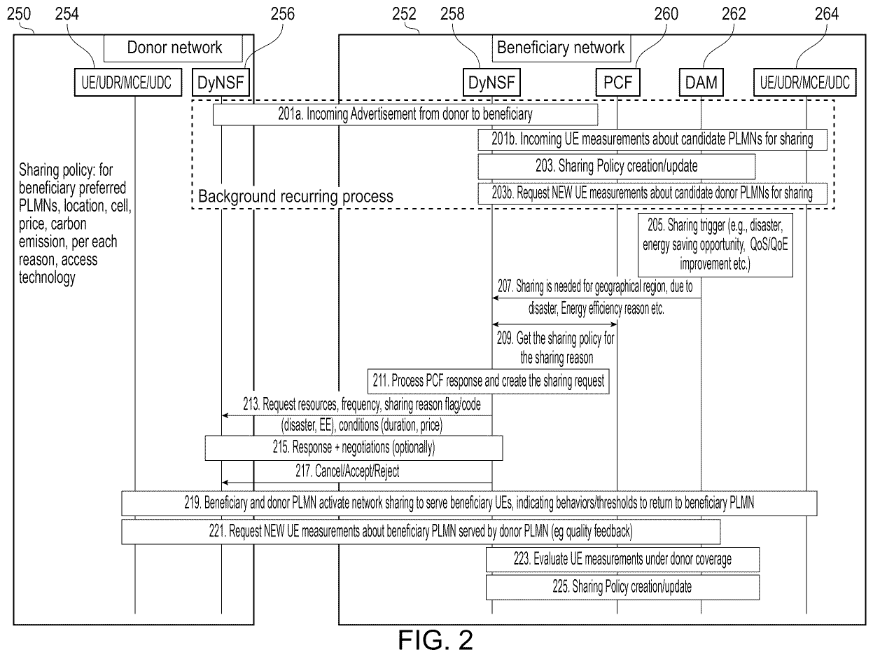

FIG. 2 describes a method for signalling between a beneficiary network 252 and a donor network 250, where the beneficiary network 252 is the initiator (e.g., requestor) of network sharing.

A background process may occur at 201a to 203b. To determine sharing partners, the beneficiary DyNCF 258 can use previous incoming advertisements from one or more donor network 250 received at 201a, and/or can use previous incoming UE measurements about candidate donor PLMNs as shown at 201b. These previous incoming UE measurements may be stored at be Measurement Repository (Measurement collection entity (MCE)), a UE data collector function (UDC), a Unified Data Repository (UDR) as shown at 264 or may be received directly from a UE.

At 203, the incoming advertisement or UE measurement can initiate a creation or update of sharing policies at PCF 260 in the beneficiary network 252 and/or may trigger a new UE measurement campaign of candidate donor PLMNs in 203b.

At 203b, the creation or update of policies (e.g., based on receiving a new advertisement from a potential donor PLMN) can trigger new UE measurement campaigns towards that donor PLMN candidate. The trigger can also be based on a reason for which dynamic network sharing is activated, for example in the case of a disaster, the new UE measurement campaign can be triggered before the PLMN is damaged. UE measurements and UE selection is discussed further below.

At 205, OAM 262 of beneficiary network 252 detects the trigger for dynamic network sharing, which may be based on a particular need (e.g., due to a disaster, energy saving or load balancing, etc.). OAM 262 may initiate sharing by signalling at 207 to DyNSF 258 the relevant geographic region and the reason for sharing. In other examples, OAM 262 role can be replaced by a Core Network Entity (e.g., Core Network Network Function NF).

At 209, DyNSF 258 receives (e.g., fetches) a sharing policy from PCF 260 (or other Core Network NF or OAM) of beneficiary network 252 corresponding to the sharing reason received at 207.

At 211, DyNSF 258 may process the PCF response and create a sharing request for resources of the donor network 250. At 213, a sharing request for the resources may be sent from DyNSF 258 to DyNSF 256 of donor network 250. The request may describe at least one of: requested resources; request frequency; a reason for the sharing request (which may be indicated as, e.g., a flag or code); conditions of the request (e.g., a requested duration or requested price). In some examples, the request can be a probe (e.g. test/enquiry) request sent to one or more donor networks.

At 215, donor network 250 may determine its available resources a return a “sharing answer” rejecting, accepting or partially accept the request with its available resources. In some cases, negotiation may between networks 250 and 252 may be performed at 215.

At 217, DyNSF 258 can accept the response provided at 215, or can reject or partially reject the response, in particular to confirm probe requests into actual requests. When partially rejecting, DyNSF 258 can negotiate further conditions with DyNSF 256 e.g., by issuing a new request.

At 219, beneficiary network 250 and donor network 252 can activate network sharing for beneficiary UE(s) 254. Behaviours and/or thresholds can also be indicated where the beneficiary UE(s) should be returned to beneficiary network 250. A node of donor network 250 serves UE 264 and broadcasts the PLMN of the first network 252.

At 221, beneficiary UE measurements about a beneficiary PLMN identifier which is now served by a donor PLMN 250 may be requested (i.e., feedback about quality may be requested). Examples of such UE measurements are discussed further below. It should be noted that when a beneficiary UE joins a sharing partner they will provide quality feedback about their serving PLMN 250. While the PLMN ID was not changed, the PLMN has been changed (frequency that PLMN is reachable was changed to the sharing partner frequency). The quality feedback about their serving PLMN 250 can be provided to the beneficiary network through forwarding by donor network. The quality feedback can be visible to the donor network to be used as evidence of e.g. QoS provided to the UE.

At 223, beneficiary UE measurements under donor coverage are evaluated at beneficiary network 252. At this step the beneficiary could evaluate whether the donor is respecting a specific Service Level Agreement (SLA) in terms of coverage or in terms of service (e.g. throughput) it is providing. These measurements could also be used to charge the UE adequately and reward/pay back the donor network for the provided service.

At 225, sharing policy enforcement may be performed. This may be as a result of the measurements at 223. In particular, if a UE provides measurements that indicate to the beneficiary that donor network 250 is not providing good coverage/service, the beneficiary network 252 may then update the sharing policy towards that donor network 250 by blocking or limiting its access, or raising an alert to be treated offline. The result of the enforcement may also lead to update of the existing (e.g., current) sharing policy or creation of a new policy.

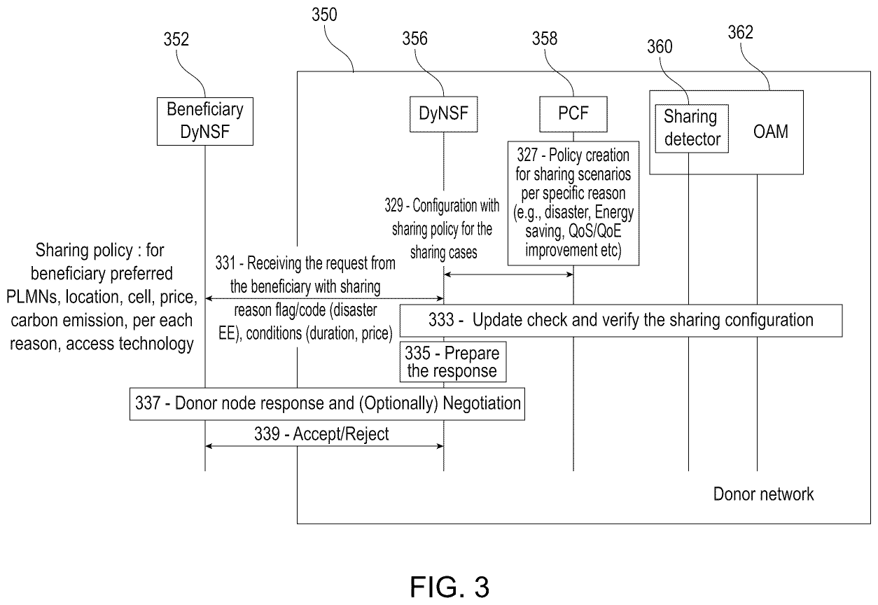

FIG. 3 shows an example of a sharing procedure from the perspective of a donor network 350 according to some embodiments.

At 327, PCF 358 donor network 250 creates sharing policies for different sharing scenarios (e.g., energy saving, disaster, load balancing, etc.).

At 329, PCF 358 configures the sharing policies at DyNSF 356 according to the generated policies. DyNSF 356 may subscribe to sharing policy updates at PCF 358.

At 331, PCF 358 receives a request for resources as described above with respect to FIG. 2. The request may include a reason for the sharing request (or a corresponding flag/code) and various technical details (e.g., on frequency bands, target location, time, PLMN ID, etc.). The request may be a probe request.

At 333, DyNSF 356 may check the network sharing conditions. This may include checking available resource, the sharing policy for the reason (e.g., use case), received at 331, and/or checking the MNO specific policies for the given reason (e.g., use case).

At 335, DyNSF 356 prepares a response. As the policy may differ based on the reason (e.g., use case), the response from DyNSF 356 can be different per use case.

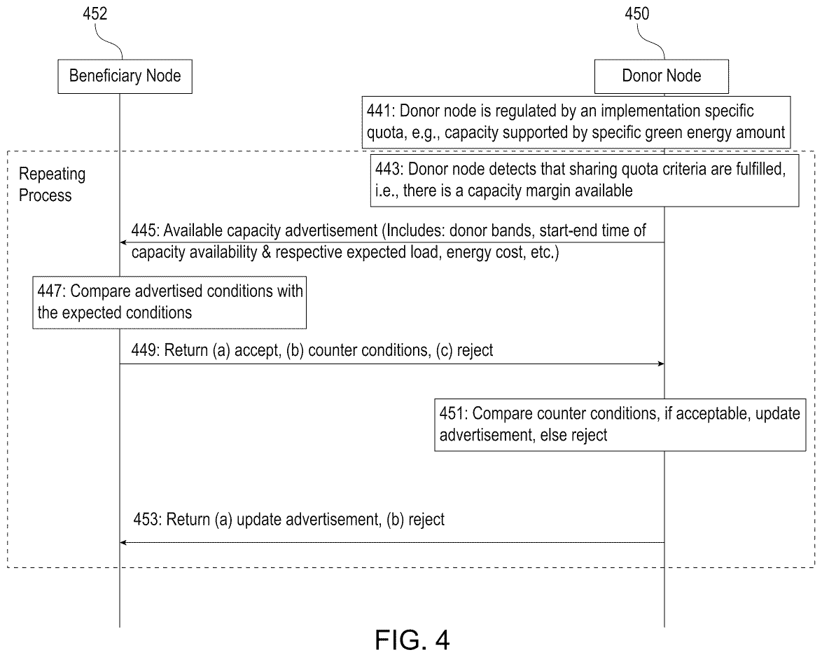

At 337, based on the sharing conditions, DyNSF 356 of the donor node sets up a response, and informs the beneficiary node 352. The response conditions may be different from the original request, as it is determined by the available resources in donor network 250. If the response is different from the original request, a negotiation may be triggered as described below with respect to FIG. 4.

At 339, after response at 337 (and in some examples, after negotiations), beneficiary node 350 may either accept or reject the proposed sharing configuration, in particular to confirm probe requests.

FIG. 4 shows an example advertisement method that can be performed between a beneficiary node 452 and a donor node 450 according to some embodiments. The advertisement method may be used in the recurring incoming advertisement step 201a described above with respect to FIG. 2, for example sent spontaneously or periodically based on an internal or external trigger. The advertisement method may be used in the negotiation steps 215 and 337 described above with respect to FIGS. 2 and 3. The negotiation method may be used, for example, in non-disaster cases for inter-MNO negotiation.

Donor node 450 (e.g., DyNSF or gNB) may be regulated by an implementation specific quota (e.g., capacity supported by a specific green energy amount, etc.).

At 443, donor node 450 determines that sharing quota criteria are fulfilled (i.e. that there is a capacity margin available), and creates an available capacity advertisement. In some examples, the need to maximize the energy efficiency of a network which is currently sufficiently loaded could trigger the sending (i.e. forwarding) of such advertisement looking for beneficiaries to host their UEs. In some examples, donor node periodically verifies these sharing quota criteria.

At 445, the donor DyNSF 450 forwards the available capacity advertisement to the DyNSF 452 of the beneficiary MNO. In another example, the donor sharing function may forward advertisements from one or more donor nodes to one or more beneficiary sharing functions. In another example, the donor sharing function may aggregate information from one or more donor nodes and send an advertisement to a beneficiary sharing function, valid for the beneficiary nodes in a geographical area (added to the advertisement). In another example, the donor sharing function may not receive an advertisement from one or more donor node, and autonomously generate an available capacity advertisement based on similar information retrieved via other means, e.g., OAM. In some examples, the identification of the beneficiary nodes to send this advertisement may be based on internal sharing policies. In some examples, the advertisement may be sent to an intermediary (e.g., broker node of an organisation independent from one or more beneficiaries).

The beneficiary sharing node 452 (e.g. DyNSF or gNB) receives the advertisement from the donor node. In some examples, the beneficiary sharing node (e.g. DyNSF) propagates the received advertisement to another beneficiary node (e.g. gNB). In another example, the beneficiary sharing node (e.g. DyNSF) may propagate advertisements from one or more donor nodes to one or more beneficiary nodes (e.g. gNB). In another example, the beneficiary sharing node (e.g. DyNSF) may propagate advertisements to one or more beneficiary nodes (e.g. gNB) in an optimized way (e.g., based on the provided geographical area).

After receiving the initial advertisement, the potential beneficiary node 452 evaluates the advertisement at 447. Based on the outcome of this evaluation:
Beneficiary node 452 can return an “accept” message at 449 to the donor node to indicate that the advertised aspects are “ok.” In another example, the beneficiary can create a new “sharing request” message to send to the donor with e.g. a subset of the advertised aspects.
If the advertised conditions are not within the acceptable region for the potential beneficiary node 450, at 449 node 450 may return a counteroffer to indicate the preferred/acceptable conditions for the advertised resources.
If the advertisement is not acceptable due to unnegotiable reasons (e.g., due to competitive reasons for the given region, regulatory aspects, service availability at the donor cell etc.), at 449 beneficiary node 450 can directly send a “reject” response to indicate that it is closed for any follow ups for the particular advertisement.
Depending on the agreements or the execution of the sharing among MNOs, the beneficiary node 450 can use the counter-offer messaging at 449 to provide a bid to the donor node 452. The donor node 452 can later decide a winning bid and provide a response.

At 451, upon receipt of a counteroffer message, donor node 450 may re-evaluate the advertisement and determine whether and how to proceed with sharing procedure. If donor node 450 receives a counter-offer from beneficiary node 452, donor node 450 may evaluate if the given conditions are acceptable for the advertised resources. Here the donor node may choose to perform admission control of potential resource reallocation or some configurations to accept the request. If with new configurations, the donor node manages to create an advertisement where the resources can be shared for the given conditions, a new advertisement with the new resource configuration is prepared. If the configuration is not changed, but only a portion of the conditions are changed, the donor re-sends the previous advertisement with the updated conditions. Acceptability of the counter-offer to the donor node 450 may be determined by the donor node based on to change in the conditions, or changing the advertised resources (donor bands), availability duration of the resources etc. Receiving the counteroffer, donor node 450 may, in some examples, determine to optimize some its resource allocation to meet the counter-offer.

If at 449, beneficiary node 452 returned a bidding for advertised resources, donor node 450 may evaluate the bid along with other bids and determine the winning bid. After this determination, donor node 450 may at 453 send an indication the accepted bid to the winning beneficiary 452 for the network sharing.

At 453, an updated advertisement may be provided to the beneficiary node. If the counter-offer is not acceptable to donor node 450, donor node 450 may send a rejection at 453.

When the new advertisement is received, although the complete process can be repeated (e.g., for the updated resources cases mentioned in option 1), from the beneficiary perspective the conditions are at the acceptable level. Therefore, it directly sends accept message to initiate the sharing. For the cases of hostile actions, e.g., beneficiary node 452 resends a new set of conditions for the same resources or rejects after the negotiation process, donor node 450 may choose to blacklist node 452 to exclude it from future sharing opportunities.

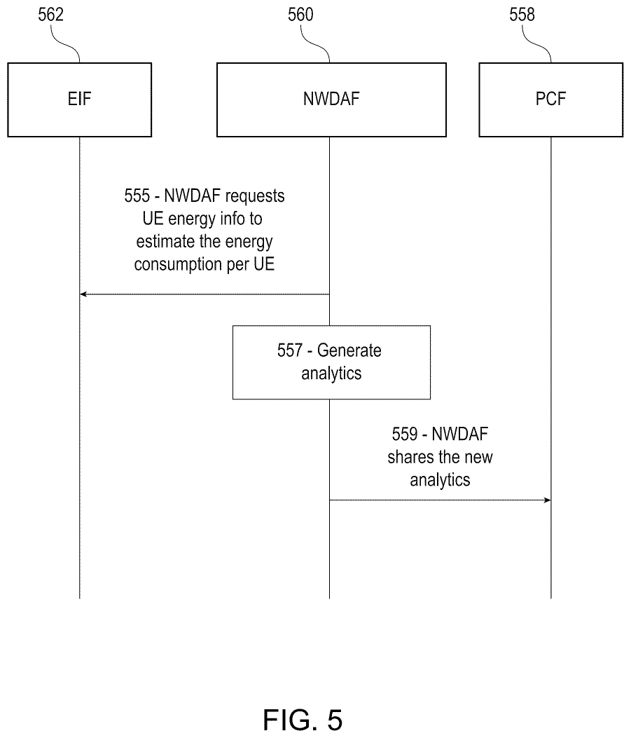

FIG. 5 shows a method for creating a sharing policy and/or updating the sharing policy at the donor side according to some embodiments.

To decide to perform network sharing, the following may occur: requires (1) determining what is the expected conditions for the required resources, (2) configuring/checking the sharing policies for the given region and (3) comparing the expected conditions with the advertised conditions.

To determine the expected sharing condition, in particular for energy saving reasons, NWDAF 560 may at 555 collect a predicted UE's energy impact from Energy Information Function 563 (e.g., from a gNB, UPF and AF) to create new analytics. At 557, NWDAF may generate analytics aimed to generate a sharing policy. At 559, NWDAF 560 may share the new analytics to PCF 558 for generating a sharing policy.

Sharing policy conditions may include:
i. Min/Max Price (e.g., Per UE/minute);
ii. Geographical location of the resources/sharing;
iii. Amount of requested resources;
iv. Available donor options/resources;
v. Pricing differentials (e.g., better or worst part of the spectrum, specific hardware, etc.); and/or
vi. Carbon footprint offset (e.g., max per UE/minute).

AF, NWDAF 560 and OAM at the doner network may configure sharing policies at PCF 558. PCF 558 may provide these conditions to a donor-side DyNSF.

Operators may have different policies for different locations (e.g., driven by their business dynamics), times of day, or sharing partners (e.g., different SLAs). When a request is received from the requestor, it is to be considered within the correct context & policy.

To track the correct context information, a sharing policy entry can be used that can comprises three parts:
the expected/preferred conditions (this can come from NWDAF 560),
beneficiary-based policies such as excluded or allowed MNOs (this can come from OAM), and/or
carbon/energy-based sharing policies (this can come from AF).

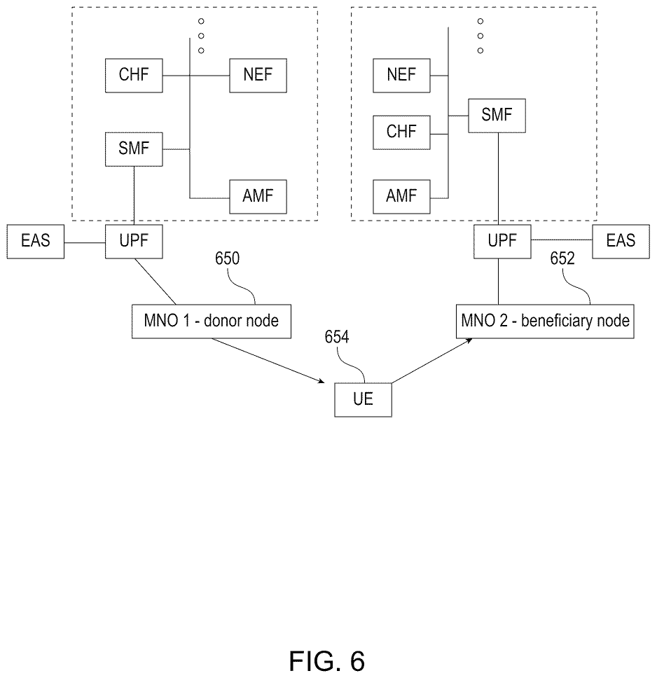

A procedure for inter-MNO discovery between an MNO 1 (donor node) 650 and MNO 2 (beneficiary node 652) according to some embodiments is now discussed with respect to FIG. 6. The discovery may be delegated via UE 654.

The delegated discovery procedure can be used both by the donor 560 and the beneficiary 652 PLMNs to determine the optimal potential sharing partners around the geographical area and to create or update the respective sharing policies.

UE 654 of a beneficiary MNO 2 may scan for available VPLMNS (i.e. candidate donor PLMNs such as MNO 1) and can perform measurements.

In some examples, the measurements may be performed by UE 654 while served by beneficiary node 652. UE 654 may be configured to measure and report detectable VPLMN(s) and Received Reference Signal Power (RSRP) of the VPLMN(s) to beneficiary node 652. These measurements before sharing establishment, on other cells of other available (“detected”) VPLMNs could help understand which VPLMNs are available/optimal for sharing under a specific area, even if the beneficiary UE 654 is not yet connected to it.

In some examples, the measurements may be performed by UE 654 while UE 654 is already served by donor-PLMN 650 architecture. This can be performed when a donor PLMN 650 node broadcasts a beneficiary PLMN ID i.e., network sharing is activated. UE 654 can be configured to report RSRP for its serving cell, strongest inter-freq cell and strongest inter-RAT cell.

The UE measurements on the detected cell of VPLMN could be performed before sharing establishment and/or after sharing establishment. After sharing establishment, the UE measurement can help to verify that the UE is effectively served by that VPLMN (e.g., for charging purposes) and/or to verify that the VPLMN is effectively serving a specific area and at the committed and acceptable conditions according to the sharing policy (e.g., bitrate, QoS etc).

UEs are configured to perform and report logged measurements for certain VPLMNs cells, which it detects including inter-frequency and inter-RAT (Radio Access Technology) measurements. This includes measurements like signal strength, RSRP, and RSRQ (Reference Signal Received Quality), and Interference levels (3GPP TS23.700-13-v1.0.0).

In addition to or instead of measuring radio quality, a QoS level achieved by UE 654 can be tracked while network sharing is active. For this, VPLMNs can select a specific UE to generate signaling based trace or signaling based MDT and request to report the UE throughput while being served to estimate if the quality of the service offered matches the committed SLA. The measurements may be configured per UE throughput, per PDU session throughput, per slice throughput and/or per QoS flow throughput.

If the VPLMN (i.e. donor) and the HPLMN (i.e. beneficiary) are not configured with same slice or with the same operator-defined 5G QoS Identifier (5QI), the VPLMN may be configured with the slice mapping and the 5QI mapping in order to match the end result files in the Trace Control Entity (TCE).

The TCE may be shared as part of the RAN sharing policy so that the measurement files can be accessed by any partner MNO to evaluate the quality of beneficiary UEs. Alternatively, the UEs can collect and report quality statistics when they are back from donor to beneficiary.

Alternatively, the VPLMN 5GC may delegate to the RAN the selection of the UEs to collect the above measurements using management-based trace or management-based MDT. In this case, the operator can make a correlation between the radio conditions of the selected beneficiary UEs and the final quality of service they received in the VPLMN.

In some examples, the VPLMN based on HPLM request or not may define a QoE Measurement Collection (QMC) configuration associated with the beneficiary UEs in order to collect the quality of experience data at application level. The QMC reporting may be compared to the quality which was expected as per the SLA.

In some examples, UE 654 may be requested to perform the following types of measurements (see 3GPP TS 36.331) for assessment of donor PLMN 650. These measurements are performed based on OAM based configuration trigger/parameters provisioned to UE as described in TS 32.422 when UE is camping in the H-PLMN, or as part of initial UE configuration procedure:
Intra-frequency measurements: measurements at the downlink carrier frequency(ies) of the serving cell(s).
Inter-frequency measurements: measurements at frequencies that differ from any of the downlink carrier frequency(ies) of the serving cell(s).
Inter-RAT measurements of NR frequencies.
Inter-RAT measurements of UTRA frequencies.
CBR measurements for V2X sidelink communication.
Sensing measurements for V2X sidelink communication.

Determining which UE(s) to use to perform measurements can depend on the network sharing scenario/purpose. With the objective to determine where to move the UEs (e.g., for energy efficiency purpose), all the UEs connected to a PLMN are selected to perform measurements.

Alternatively, if the purpose of the measurements is to collect the availability of the PLMNs and to generate a location-based sharing policy, UEs that will provide the maximum information can be selected to perform the measurement task. Therefore, a subset of the UEs, e.g., connected to the PLMN, are selected to minimize the signaling overhead. For example, DyNSF checks UE Context data in the UDM/UDR directly or indirectly (e.g., through a UE data collection function) and determines UEs in CM_connected mode and located in a particular Tracking Area (or TAI). Or AMF may receive a list of UEs from DyNSF to provide measurement and accordingly AMF forwards this information to the gNB serving those UEs.

In another examples, DyNSF gets the list of UEs information directly from OAM. After this step, the network generates the sharing policies and determines which PLMNs to use (e.g. in case of a disaster) and provisions this information to the UE. Unlike the current implementation of having a prioritized list, with this approach the UE knows exactly which PLMN to connect, which speeds up the process and decreases the signalling.

For evaluation and enforcement of the sharing policy based on QoS measurements, if the evaluation is mostly driven by coverage, then selection of the beneficiary UEs by the RAN may be preferred through management-based trace/MDT and core network contacting the relevant RAN nodes. If evaluation of the sharing policy is mostly driven by the offered service, signaling based trace/MDT or QMC configuration should preferably be used with selection of UEs performed by the core network.

FIG. 7 shows an example of a method. The method may be computer-implemented according to some embodiments. The method may be performed by a UE, such as UE 264.

As shown in FIG. 7, at 710, the method comprises receiving, from a first network, a configuration related to performance measurements of candidate networks for network sharing with the first network.

At 720, the method comprises: while being served by the first network, detecting a node of at least one other network.

At 730, the method comprises: measuring the at least one other network based on the configuration.

At 740, the method comprises: reporting at least one performance measurement of the least one other network to the first network.

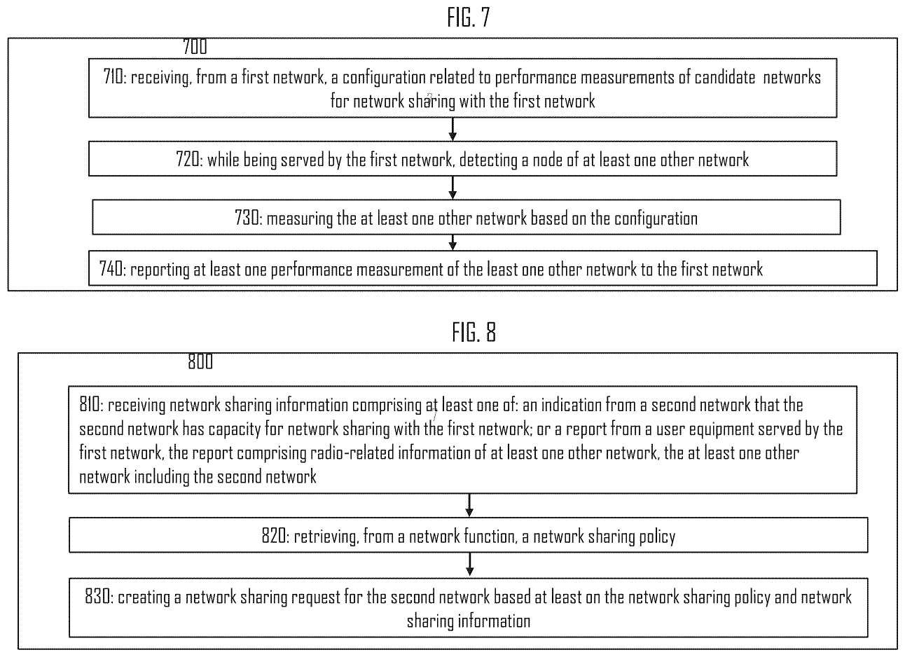

FIG. 8 shows an example of a method according to some embodiments. The method may be computer-implemented. The method may be performed by DyNSF 258, for example.

As shown in FIG. 8, at 810, the method comprises: receiving network sharing information comprising at least one of: an indication from a second network that the second network has capacity for network sharing with the first network; or a report from a user equipment served by the first network, the report comprising radio-related information of at least one other network, the at least one other network including the second network.

At 820, the method comprises retrieving, from a network function, a network sharing policy.

At 830, the method comprises creating a network sharing request for the second network based at least on the network sharing policy and network sharing information.

FIG. 9 shows an example of a method according to some embodiments. The method may be computer-implemented. The method may be performed by a PCF such as PCF 260, for example.

As shown in FIG. 9, at 910, the method comprises: receiving network sharing information comprising at least one of: an indication from at least one other network that the at least one other network has capacity for network sharing with a first network; or a report from a user equipment served by the first network, the report comprising a signal strength of the at least one other network.

At 920, the method comprises creating a network sharing policy for the first network and the at least one other network based on the sharing information.

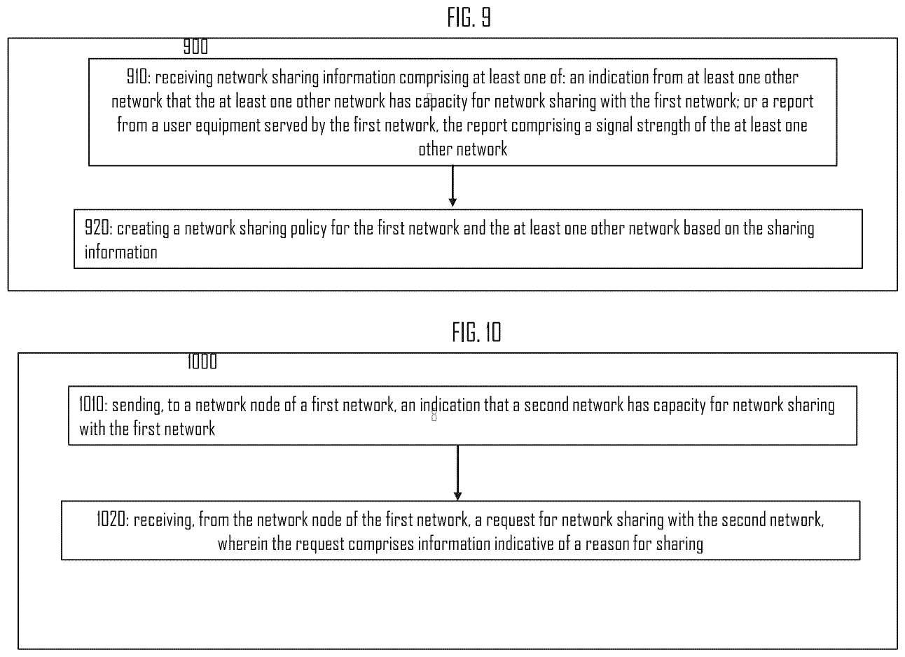

FIG. 10 shows an example of a method according to some embodiments. The method may be computer-implemented. The method may be performed by DyNSF 256, for example.

As shown in FIG. 10, at 1010, the method comprises: sending, to a network node of a first network, an indication that second network has capacity for network sharing with the first network.

At 1020, the method comprises: receiving, from the network node of the first network, a request for network sharing with the second network, wherein the request comprises information indicative of a reason for sharing.

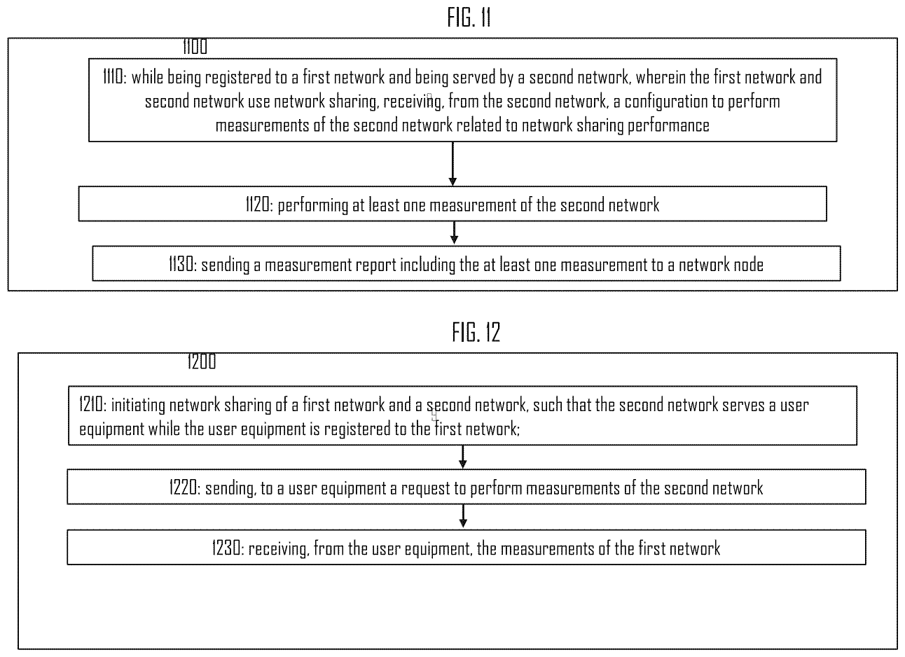

FIG. 11 shows an example of a method according to some embodiments. The method may be computer-implemented. The method may be performed by UE 264, for example.

As shown in FIG. 11, at 1110, the method comprises: while being registered to a first network and being served by a second network, wherein the first network and second network use network sharing, receiving, from the second network, a configuration to perform measurements of the second network related to network sharing performance.

At 1120, the method comprises: performing at least one measurement of the second network.

At 1130, the method comprises: sending a measurement report including the at least one measurement to a network node.

FIG. 12 shows an example of a method according to some embodiments. The method may be computer-implemented. The method may be performed by DyNSF 258, for example.

As shown in FIG. 12, at 1210, the method comprises: initiating network sharing of a first network and a second network, such that the second network serves a user equipment while the user equipment is registered to the first network.

At 1220, the method comprises: sending, to a user equipment a request to perform measurements of the second network.

At 1230, the method comprises: receiving, from the user equipment, the measurements of the first network.

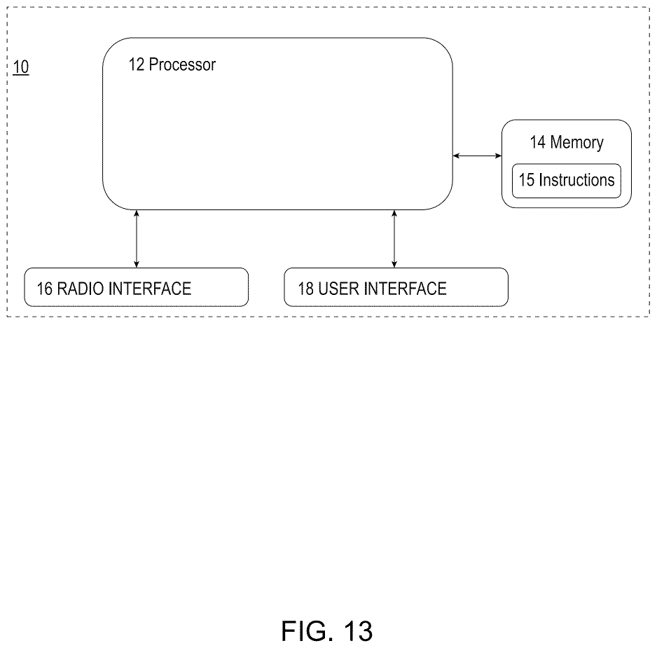

FIG. 13 shows, by way of example, a block diagram of an apparatus 10 according to some embodiments. The apparatus 10 comprises, for example, at least one processor 12 and at least one memory 14 storing instructions 15 that, when executed by the at least one processor, cause the apparatus 10 at least to perform the method or methods as disclosed herein, and any of the embodiments thereof. In an example, the at least one memory and the instructions (e.g. a computer program code, software), are configured, with the at least one processor, to cause the apparatus 10 to perform the method or methods as disclosed herein, and any of the embodiments thereof.

A processor 12 may comprise circuitry, or be constituted as circuitry or circuitries, the circuitry or circuitries being configured to perform phases of methods in accordance with any embodiments (or portion(s) thereof) described herein.

As used herein, the term “circuitry” may refer to one or more or all of the following: (a) hardware-only circuit implementations, such as implementations in analog, digital and/or quantum circuitry, and (b) combinations of hardware circuit(s) and software, such as, as applicable: (i) a combination of analog, digital and/or quantum hardware circuit(s) with software/firmware and (ii) any or all portions of hardware processor(s) (including digital and/or quantum processor(s)) with software, and memory(ies) that work together to cause an apparatus, such as a a modbile device (e.g., user equipment, terminal device, etc.), to perform various functions) and (c) any or all portions of hardware circuit(s), such as microprocessor(s), and/or quantum processor(s), that require software (e.g., firmware) for operation, but the software may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 14 may be implemented using any suitable data storage technology. The memory may comprise a database for storing data. The memory 14 may be at least in part external to apparatus 10 but accessible to apparatus 10.

The instructions 15 may be comprised in a computer readable medium or a non-transitory computer readable medium. A term “non-transitory,” as used herein, is a limitation of the medium itself (i.e. tangible, not a signal) as opposed to a limitation on data storage persistency (e.g. random-access memory, RAM, vs. read only memory, ROM).

For example, the apparatus 10 is a terminal device. As another example, the apparatus is comprised in such a terminal device, e.g. as a chipset configured to control the terminal device.

The apparatus 10 may be caused or configured to perform at least the method of one or more of the embodiments described.

The apparatus 10 comprises a radio interface 16. The radio interface 16 may provide the apparatus 10 with communication capabilities. The radio interface 16 may comprise a receiver configured to receive information in accordance with at least one cellular or non-cellular standard. The radio interface 16 may comprise a transmitter configured to transmit information in accordance with at least one cellular or non-cellular standard. The receiver may comprise more than one receiver. The transmitter may comprise more than one transmitter. The radio interface 16 may comprise a transceiver configured to receive and transmit information in accordance with at least one cellular or non-cellular standard. The transceiver may comprise more than one transceiver.

The apparatus 10 may comprise an interface (e.g., a user interface) 18 comprising, for example, at least one of a keypad, a microphone, a touch display, a display, a speaker, etc. The interface 18 may be used to control the apparatus by the user. The interface 18 may be external to the apparatus 10. For example, the apparatus 10 may be connected to another device, such as a computer, either via wireless or wired connection, and the apparatus 10 is controlled via the computer.

In an embodiment, at least some of the processes described herein may be carried out by an apparatus comprising means for carrying out at least some of the described processes. Means for performing method steps as disclosed herein may include software and/or hardware components of the apparatus 10. For example, the at least one processor 12, the memory 14, and the computer program code form means for carrying out the method or methods as disclosed herein, and any of the embodiments thereof.

In some embodiments, further examples are provided in Appendix A.

In some embodiments, further examples are provided in Appendix B. As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

Following is a list of some aspects.

According to a first aspect, there is provided a method performed by a user equipment, the method comprising: receiving, from a first network, a configuration related to performance measurements of candidate networks for network sharing with the first network; while being served by the first network, detecting a node of at least one other network; measuring the at least one other network based on the configuration; and reporting at least one performance measurement of the least one other network to the first network,

Various embodiments of the first aspect may comprise at least one feature from the following bulleted list:
the first network comprises a beneficiary Public Land Mobile Network, PLMN;
the configuration comprises at least one of: a list of PLMNs that are candidates for network sharing with the first network; or a list of frequency layers in which candidates for network sharing with the first network can be operating;
the configuration is for at least one of: Reference Signal Received Power, RSRP, measurements; Reference Signal Received Quality, RSRQ measurements; interference level measurements; inter-frequency measurements; or inter-Radio Access Technology, RAT, measurements;
the method further comprises: receiving a request to perform further measurements of the at least one other network;
performing the further measurements; and sending a report to the first network of the further measurements of the at least one other network;
the further measurements of the at least one other network comprise at least one of: RSRP measurements of the at least one other network; Quality of Service, QoS, measurements of the at least one other network; or Quality of Experience, QoE, measurements of the at least one other network.

According to a second aspect, there is provided a method, comprising: receiving network sharing information comprising at least one of: an indication from a second network that the second network has capacity for network sharing with the first network; or a report from a user equipment served by the first network, the report comprising radio-related information of at least one other network, the at least one other network including the second network; retrieving, from a network function, a network sharing policy, and creating a network sharing request for the second network based at least on the network sharing policy and network sharing information.

Various embodiments of the second aspect may comprise at least one feature from the following bulleted list:
the method further comprises sending the network sharing information to the network function;
the network function comprises policy and control function, PCF;
the method further comprises requesting further measurements from the user equipment for the second network;
the method further comprises: receiving the further measurements from the user equipment; retrieving, from the network function, a second network sharing policy; and creating a second network sharing request for the second network based on least on the network sharing policy and the further measurements;
the method further comprises: receiving an indication, from an Operations, Administration and Maintenance, OAM, a core network function or other network function, that network sharing is required for a sharing case; retrieving, from the network function, a network sharing policy for the sharing case; generating a sharing request based on the sharing policy; and sending the sharing request to the at least one other network;
the request comprises at least one of: a request for a frequency range; information indicative of a reason for requesting sharing; of requested conditions of the sharing;
the reason comprises at least one of: a declared public disaster; an undeclared disaster; energy efficiency or energy saving purposes; extending coverage; or flexible network resource management;
the method further comprises: receiving a response from the second network, the response comprising total or partial acceptance of the request, a rejection of the request or a counter-offer for the request;
the method further comprises: sending a request to the user equipment to perform further measurements of the second network; and receiving a report from the user equipment of the further measurements of the second network; and sending the report from the user equipment of the further measurements of the second network to the network function;
the method further comprises: retrieving, from the network function, a third network sharing policy; and creating a third network sharing request for the second network based on least on the third network sharing policy and the report;
the further measurements of the at least one other network comprise at least one of: RSRP measurements of the at least one further network; Quality of Service, QoS, measurements of the at second network; or Quality of Experience, QoE, measurements of the second network

According to a third aspect, there is provided a method comprising: receiving network sharing information comprising at least one of: an indication from at least one other network that the at least one other network has capacity for network sharing with a first network; or a report from a user equipment served by the first network, the report comprising a signal strength of the at least one other network; creating a network sharing policy for the first network and the at least one other network based on the sharing information.

Various embodiments of the third aspect may comprise at least one feature from the following bulleted list:
the method further comprises receiving a request comprising information indicative of a reason for network sharing; selecting a sharing policy based on the request; and sending the sharing policy to a network node of the first network;
the method further comprises: receiving further measurements performed by the user equipment of the at least one other network, wherein the further measurements are obtained during the first network serving the user equipment; and based on the further measurements, creating a new sharing policy or updating the sharing policy.

According to a fourth aspect, there is provided a method comprising: sending, to a network node of a first network, an indication that second network has capacity for network sharing with the first network; and receiving, from the network node of the first network, a request for network sharing with the second network, wherein the request comprises information indicative of a reason for sharing.

Various embodiments of the fourth aspect may comprise at least one feature from the following bulleted list:
the method further comprises causing the second network to serve a user equipment registered to the first network;
the method further comprises: receiving, from a network node, one or more sharing policies at least corresponding to the received sharing reason;
the network node is configured to provide a PCF;
the request comprises requested conditions for the network sharing;
the method further comprises: in response to the request, sending, to the network node of the first network, information indicating total or partial acceptance of the request, rejection of the request or a counter-offer to the request;
the method determining that the second network has capacity for network sharing; and sending an indication to the first network that the second network has capacity for network sharing

According to a fifth aspect, there is provided a method comprising: while being registered to a first network and being served by a second network, wherein the first network and second network use network sharing, receiving, from the second network, a configuration to perform measurements of the second network related to network sharing performance; performing at least one measurement of the second network; and sending a measurement report including the at least one measurement to a network node.

Various embodiments of the fifth aspect may comprise at least one feature from the following bulleted list:
the network node belongs to the second network;
the network node belongs to the first network and the measurement report is sent after network sharing is deactivated;
the second network broadcasts the Public Land Mobile Network, PLMN, of the first network;
the configuration comprises at least one measurement threshold derived from at least one Service Level Agreement, SLA, requirement;
the measurements comprise Reference Signal Received Power, RSRP, measurements of the second network;
the configuration comprises a request to measure at least one of: the Quality of Service, QoS, measurements of the at least one further network; or Quality of Experience, QoE, measurements of the at least one further network; per UE throughput; per PDU session throughput; per slice throughput; per QoS flow throughput;
the measurement report indicates whether the at least one measurement threshold is met or overcome;
the method further comprises: performing further RSRP measurements for a strongest inter-frequency cell and a strongest inter Radio Access Technology cell; and reporting the further measurements to the network node of the first network;
the method further comprises: receiving a QoE Measurement Collection, QMC, configuration; and reporting QoE measurements to the network node of the first network based on the QMC configuration;
the first network is served by a beneficiary PLMN and the second network is served by a donor PLMN.

According to a sixth aspect, there is provided a method comprising: initiating network sharing of a first network and a second network, such that the second network serves a user equipment while the user equipment is registered to the first network; sending, to a user equipment a request to perform measurements of the second network; and receiving, from the user equipment, the measurements of the first network.

Various embodiments of the sixth aspect may comprise at least one feature from the following bulleted list:
the measurements comprise Reference Signal Received Power, RSRP, measurements of the second network;
the measurements comprise at least one of: Quality of Service, QoS, measurements of the at least one further network; or Quality of Experience, QoE, measurements of the at least one further network;
the measurements indicate whether a Service Level Agreement, SLA, between the network node and the user equipment is satisfied;
the method further comprises: receiving at least one QoE measurement from the user equipment, the at least one QoE measurement based on a QMC configuration applied at the user equipment; and creating a second sharing policy for the first network and the second network or updating a sharing policy for the first network and the second network;
the method further comprises: receiving, from the user equipment, further RSRP measurements for a strongest inter-frequency cell and a strongest inter Radio Access Technology cell; and creating a third sharing policy for the first network and the second network or updating a sharing policy for the first network and the second network.

According to a seventh aspect, there is provided a user equipment, comprising: comprising at least one processor and at least one memory storing instructions that, when executed by the at least one processor, cause the user equipment at least to perform: receiving, from a first network, a configuration related to performance measurements of candidate networks for network sharing with the first network; while being served by the first network, detecting a node of at least one other network; measuring the at least one other network based on the configuration; and reporting at least one performance measurement of the least one other network to the first network.

Various embodiments of the seventh aspect may comprise at least one feature from the bulleted list under the first aspect.

According to an eighth aspect, there is provided an apparatus of a first network, the apparatus comprising at least one processor and at least one memory storing instructions that, when executed by the at least one processor, cause the apparatus at least to perform: receiving network sharing information comprising at least one of: an indication from a second network that the second network has capacity for network sharing with the first network; or a report from a user equipment served by the first network, the report comprising radio-related information of at least one other network, the at least one other network including the second network; retrieving, from a network function, a network sharing policy, and creating a network sharing request for the second network based at least on the network sharing policy and network sharing information.

Various embodiments of the eighth aspect may comprise at least one feature from the bulleted list under the second aspect.

According to an nineth aspect, there is provided an apparatus of a first network, the apparatus comprising at least one processor and at least one memory storing instructions that, when executed by the at least one processor, cause the apparatus at least to perform: receiving network sharing information comprising at least one of: an indication from at least one other network that the at least one other network has capacity for network sharing with the first network; or a report from a user equipment served by the first network, the report comprising a signal strength of the at least one other network; creating a network sharing policy for the first network and the at least one other network based on the sharing information.

Various embodiments of the nineth aspect may comprise at least one feature from the bulleted list under the third aspect.

According to a tenth aspect, there is provided an apparatus of a second network, the apparatus comprising at least one processor and at least one memory storing instructions that, when executed by the at least one processor, cause the apparatus at least to perform: sending, to a network node of a first network, an indication that second network has capacity for network sharing with the first network; and receiving, from the network node of the first network, a request for network sharing with the second network, wherein the request comprises information indicative of a reason for sharing.

Various embodiments of the tenth aspect may comprise at least one feature from the bulleted list under the fourth aspect.

According to an eleventh aspect, there is provided a user equipment comprising at least one processor and at least one memory storing instructions that, when executed by the at least one processor, cause the user equipment at least to perform: while being registered to a first network and being served by a second network, wherein the first network and second network use network sharing, receiving, from the second network, a configuration to perform measurements of the second network related to network sharing performance; performing at least one measurement of the second network; and sending a measurement report including the at least one measurement to a network node.

Various embodiments of the eleventh aspect may comprise at least one feature from the bulleted list under the fifth aspect.

According to an twelfth aspect, there is provided an apparatus of a first network comprising at least one processor and at least one memory storing instructions that, when executed by the at least one processor, cause the apparatus at least to perform: initiating network sharing of a first network and a second network, such that the second network serves a user equipment while the user equipment is registered to the first network; sending, to a user equipment a request to perform measurements of the second network; and receiving, from the user equipment, the measurements of the first network.

Various embodiments of the twelfth aspect may comprise at least one feature from the bulleted list under the sixth aspect.

According to a thirteenth aspect, there is provided a computer program product embodied on a distribution medium and comprising program instructions which, when executed by an apparatus, cause the apparatus to carry out the method according to the first, second, third, fourth, fifth or sixth aspect.

According to a sixth aspect, there is provided a computer program product comprising program instructions which, when executed by an apparatus, cause the apparatus to carry out the method according to the first, second, third, fourth, fifth or sixth aspect.

According to a seventh aspect, there is provided an apparatus, comprising means for performing the method according to the first aspect or according to the second aspect, and/or means configured to cause the apparatus to perform the method according to the first, second, third, fourth, fifth or sixth aspect.

Even though the various embodiments of this disclosure have been described above with reference to an example according to the Figures, it is clear that this disclosure is not restricted thereto but can be modified in various manners. Therefore, all words and expressions should be interpreted broadly, and they are intended to illustrate, not to restrict, the respective embodiment. It will be obvious to a person skilled in the art that, as technology advances, the various embodiments of this disclosure can be implemented in various ways. Further, it is clear to a person skilled in the art that the described embodiment(s) (or portion(s) thereof) may, but are not required to, be combined with any other embodiment(s) (or portion(s) thereof) in various ways to form additional embodiments.

### APPENDIX B

Example 1.A user equipment comprising at least one processor and at least one memory storing instructions that, when executed by the at least one processor, cause the user equipment at least to perform:
receiving, from a first network, a configuration related to performance measurements of candidate networks for network sharing with the first network;
while being served by the first network, detecting a node of at least one other network;
measuring the at least one other network based on the configuration; and
reporting at least one performance measurement of the least one other network to the first network.

Example 2. The user equipment according to Example 1, wherein the first network comprises a beneficiary Public Land Mobile Network, PLMN.

Example 3. The user equipment according to Example 1 or 2, wherein the configuration comprises at least one of: a list of PLMNs that are candidates for network sharing with the first network; or a list of frequency layers in which candidates for network sharing with the first network can be operating.

Example 4. The user equipment according to any preceding Example, wherein the configuration is for at least one of:
Reference Signal Received Power, RSRP, measurements;
Reference Signal Received Quality, RSRQ measurements;
interference level measurements;
inter-frequency measurements; or
inter-Radio Access Technology, RAT, measurements.

Example 5. The user equipment according to any preceding Example, wherein the instructions, when executed by the at least one processor, cause the user equipment at least to perform:
receiving a request to perform further measurements of the at least one other network;
performing the further measurements; and
sending a report to the first network of the further measurements of the at least one other network.

Example 6. The user equipment according to Example 5, wherein the further measurements of the at least one other network comprise at least one of:
RSRP measurements of the at least one other network;
Quality of Service, QoS, measurements of the at least one other network; or
Quality of Experience, QoE, measurements of the at least one other network.

Example 7. The user equipment according to any preceding Example, wherein the first network is associated with a first PLMN and the second network is associated with a second PLMN.

Example 8. A method performed by a user equipment, the method comprising:
receiving, from a first network, a configuration related to performance measurements of candidate networks for network sharing with the first network;
while being served by the first network, detecting a node of at least one other network;
measuring the at least one other network based on the configuration; and
reporting at least one performance measurement of the least one other network to the first network.

Example 9. A computer program comprising instructions stored thereon for performing at least the following:
receiving, from a first network, a configuration related to performance measurements of candidate networks for network sharing with the first network;
while being served by the first network, detecting a node of at least one other network;
measuring the at least one other network based on the configuration; and
reporting at least one performance measurement of the least one other network to the first network.

Example 10. An apparatus of a first network, the apparatus comprising at least one processor and at least one memory storing instructions that, when executed by the at least one processor, cause the apparatus at least to perform:
receiving network sharing information comprising at least one of: an indication from a second network that the second network has capacity for network sharing with the first network; or a report from a user equipment served by the first network, the report comprising radio-related information of at least one other network, the at least one other network including the second network;
retrieving, from a network function, a network sharing policy, and
creating a network sharing request for the second network based at least on the network sharing policy and network sharing information.

Example 11. The apparatus according to claim Example 10, wherein the instructions, when executed by the at least one processor, cause the apparatus at least to further perform: sending the network sharing information to the network function.

Example 12. The apparatus of Example 10 or claim 11, wherein the instructions, when executed by the at least one processor, cause the apparatus at least to perform:
requesting further measurements from the user equipment for the second network.

Example 13. The apparatus of any of Examples 10 to 12, wherein the instructions, when executed by the at least one processor, cause the apparatus at least to perform:
receiving the further measurements from the user equipment;
retrieving, from the network function, a second network sharing policy; and
creating a second network sharing request for the second network based on least on the network sharing policy and the further measurements.

Example 14. The apparatus of any of Examples 10 to 13, wherein the instructions, when executed by the at least one processor, cause the apparatus at least to perform:
receiving an indication, from an Operations, Administration and Maintenance, OAM, a core network function or other network function, that network sharing is required for a sharing case;
retrieving, from the network function, a network sharing policy for the sharing case;
generating a sharing request based on the sharing policy; and
sending the sharing request to the at least one other network.

Example 15. The apparatus of any of Examples 10 to 14, wherein the request comprises at least one of:
a request for a frequency range;
information indicative of a reason for requesting sharing; of
requested conditions of the sharing.

Example 16. The apparatus of Example 15, wherein the reason comprises at least one of:
a declared public disaster;
an undeclared disaster;
energy efficiency or energy saving purposes;
extending coverage; or
flexible network resource management.

Example 17. The apparatus of Example 15 or 16, wherein the instructions, when executed by the at least one processor, cause the apparatus at least to perform:
receiving a response from the second network, the response comprising total or partial acceptance of the request, a rejection of the request or a counter-offer for the request.

Example 18. The apparatus of Example 17, wherein the instructions, when executed by the at least one processor, cause the apparatus at least to perform:
sending a request to the user equipment to perform further measurements of the second network; and
receiving a report from the user equipment of the further measurements of the second network; and
sending the report from the user equipment of the further measurements of the second network to the network function.

Example 19. The apparatus of Example 18, wherein the instructions, when executed by the at least one processor, cause the apparatus at least to perform:
retrieving, from the network function, a third network sharing policy; and
creating a third network sharing request for the second network based on least on the third network sharing policy and the report.

Example 20. The apparatus according to Example 18 or 19, wherein the further measurements of the at least one other network comprise at least one of:
RSRP measurements of the at least one further network;
Quality of Service, QoS, measurements of the at second network; or
Quality of Experience, QoE, measurements of the second network.

Example 21. A method comprising:
receiving network sharing information comprising at least one of: an indication from a second network that the second network has capacity for network sharing with a first network; or a report from a user equipment served by the first network, the report comprising radio-related information of at least one other network, the at least one other network including the second network;
retrieving, from a network function, a network sharing policy, and
creating a network sharing request for the second network based at least on the network sharing policy and network sharing information.

Example 22. A computer program comprising instructions stored thereon for performing at least the following:
receiving network sharing information comprising at least one of: an indication from a second network that the second network has capacity for network sharing with a first network; or a report from a user equipment served by the first network, the report comprising radio-related information of at least one other network, the at least one other network including the second network;
retrieving, from a network function, a network sharing policy, and
creating a network sharing request for the second network based at least on the network sharing policy and network sharing information.

Example 23. An apparatus of a first network, the apparatus comprising at least one processor and at least one memory storing instructions that, when executed by the at least one processor, cause the apparatus at least to perform:
receiving network sharing information comprising at least one of: an indication from at least one other network that the at least one other network has capacity for network sharing with the first network; or a report from a user equipment served by the first network, the report comprising a signal strength of the at least one other network;
creating a network sharing policy for the first network and the at least one other network based on the sharing information.

Example 24. The apparatus according to Example 23, wherein the instructions, when executed by the at least one processor, cause the apparatus at least to perform:
receiving a request comprising information indicative of a reason for network sharing;
selecting a sharing policy based on the request; and
sending the sharing policy to a network node of the first network.

Example 25. The apparatus according to Example 24, wherein the instructions, when executed by the at least one processor, cause the apparatus at least to perform:
receiving further measurements performed by the user equipment of the at least one other network, wherein the further measurements are obtained during the first network serving the user equipment; and
based on the further measurements, creating a new sharing policy or updating the sharing policy.

Example 26. A method comprising:
receiving network sharing information comprising at least one of: an indication from at least one other network that the at least one other network has capacity for network sharing with the first network; or a report from a user equipment served by the first network, the report comprising a signal strength of the at least one other network;
creating a network sharing policy for the first network and the at least one other network based on the sharing information.

Example 27. A computer program comprising instructions stored thereon for performing at least the following:
receiving network sharing information comprising at least one of: an indication from at least one other network that the at least one other network has capacity for network sharing with the first network; or a report from a user equipment served by the first network, the report comprising a signal strength of the at least one other network;
creating a network sharing policy for the first network and the at least one other network based on the sharing information.

Example 28. An apparatus of a second network, the apparatus comprising at least one processor and at least one memory storing instructions that, when executed by the at least one processor, cause the apparatus at least to perform:
sending, to a network node of a first network, an indication that second network has capacity for network sharing with the first network; and
receiving, from the network node of the first network, a request for network sharing with the second network, wherein the request comprises information indicative of a reason for sharing.

Example 29. The apparatus according to Example 28, wherein the instructions, when executed by the at least one processor, cause the apparatus at least to perform:
causing the second network to serve a user equipment registered to the first network.

Example 30. The apparatus according to Example 28 or 29, wherein the instructions, when executed by the at least one processor, cause the apparatus at least to perform:
receiving, from a network node, one or more sharing policies at least corresponding to the received sharing reason.

Example 31. The apparatus according to Example 30, wherein the network node is configured to provide a PCF.

Example 32. The apparatus according to any of Examples 28 to 31, wherein the request comprises requested conditions for the network sharing.

Example 33. The apparatus according to Example 32, wherein the instructions, when executed by the at least one processor, cause the apparatus at least to perform:
in response to the request, sending, to the network node of the first network, information indicating total or partial acceptance of the request, rejection of the request or a counter-offer to the request.

Example 34. The apparatus according to any of Examples 28 to 33, wherein the instructions, when executed by the at least one processor, cause the apparatus at least to perform:
determining that the second network has capacity for network sharing; and
sending an indication to the first network that the second network has capacity for network sharing.

Example 35. A method comprising:
sending, to a network node of a first network, an indication that second network has capacity for network sharing with the first network; and
receiving, from the network node of the first network, a request for network sharing with the second network, wherein the request comprises information indicative of a reason for sharing.

Example 36. A computer program comprising instructions stored thereon for performing at least the following:
sending, to a network node of a first network, an indication that second network has capacity for network sharing with the first network; and
receiving, from the network node of the first network, a request for network sharing with the second network, wherein the request comprises information indicative of a reason for sharing.

1. A user equipment comprising at least one processor and at least one memory storing instructions that, when executed by the at least one processor, cause the user equipment at least to perform:
receiving, from a first network, a configuration related to performance measurements of candidate networks for network sharing with the first network;
while being served by the first network, detecting a node of at least one other network;
measuring the at least one other network based on the configuration; and
reporting at least one performance measurement of the least one other network to the first network.

2. The user equipment according to claim 1, wherein the first network comprises a beneficiary Public Land Mobile Network, PLMN.

3. The user equipment according to claim 1, wherein the configuration comprises at least one of: a list of PLMNs that are candidates for network sharing with the first network; or a list of frequency layers in which candidates for network sharing with the first network can be operating.

4. The user equipment according to claim 1, wherein the configuration is for at least one of:
Reference Signal Received Power, RSRP, measurements;
Reference Signal Received Quality, RSRQ measurements;
interference level measurements;
inter-frequency measurements; or
inter-Radio Access Technology, RAT, measurements.

5. The user equipment according to claim 1, wherein the instructions, when executed by the at least one processor, cause the user equipment at least to perform:
receiving a request to perform further measurements of the at least one other network;
performing the further measurements; and
sending a report to the first network of the further measurements of the at least one other network.

6. The user equipment according to claim 5, wherein the further measurements of the at least one other network comprise at least one of:
RSRP measurements of the at least one other network;
Quality of Service, QoS, measurements of the at least one other network; or
Quality of Experience, QoE, measurements of the at least one other network.

7. The user equipment according to claim 1, wherein the first network is associated with a first PLMN and the second network is associated with a second PLMN.

8. An apparatus of a first network, the apparatus comprising at least one processor and at least one memory storing instructions that, when executed by the at least one processor, cause the apparatus at least to perform:
receiving network sharing information comprising at least one of: an indication from a second network that the second network has capacity for network sharing with the first network; or a report from a user equipment served by the first network, the report comprising radio-related information of at least one other network, the at least one other network including the second network;
retrieving, from a network function, a network sharing policy, and
creating a network sharing request for the second network based at least on the network sharing policy and network sharing information.

9. The apparatus according to claim 8, wherein the instructions, when executed by the at least one processor, cause the apparatus at least to further perform: sending the network sharing information to the network function.

10. The apparatus of claim 8, wherein the instructions, when executed by the at least one processor, cause the apparatus at least to perform:
requesting further measurements from the user equipment for the second network.

11. The apparatus of claim 8, wherein the instructions, when executed by the at least one processor, cause the apparatus at least to perform:
receiving the further measurements from the user equipment;
retrieving, from the network function, a second network sharing policy; and
creating a second network sharing request for the second network based on least on the network sharing policy and the further measurements.

12. The apparatus of claim 8, wherein the instructions, when executed by the at least one processor, cause the apparatus at least to perform:
receiving an indication, from an Operations, Administration and Maintenance, OAM, a core network function or other network function, that network sharing is required for a sharing case;
retrieving, from the network function, a network sharing policy for the sharing case;
generating a sharing request based on the sharing policy; and
sending the sharing request to the at least one other network.

13. The apparatus of claim 8, wherein the request comprises at least one of:
a request for a frequency range;
information indicative of a reason for requesting sharing; of
requested conditions of the sharing.

14. The apparatus of claim 13, wherein the reason comprises at least one of:
a declared public disaster;
an undeclared disaster;
energy efficiency or energy saving purposes;
extending coverage; or
flexible network resource management.

15. The apparatus of claim 13, wherein the instructions, when executed by the at least one processor, cause the apparatus at least to perform:
receiving a response from the second network, the response comprising total or partial acceptance of the request, a rejection of the request or a counter-offer for the request.

16. An apparatus of a first network, the apparatus comprising at least one processor and at least one memory storing instructions that, when executed by the at least one processor, cause the apparatus at least to perform:
receiving network sharing information comprising at least one of: an indication from at least one other network that the at least one other network has capacity for network sharing with the first network; or a report from a user equipment served by the first network, the report comprising a signal strength of the at least one other network;
creating a network sharing policy for the first network and the at least one other network based on the sharing information.

17. The apparatus according to claim 16, wherein the instructions, when executed by the at least one processor, cause the apparatus at least to perform:
receiving a request comprising information indicative of a reason for network sharing;
selecting a sharing policy based on the request; and
sending the sharing policy to a network node of the first network.

18. The apparatus according to claim 17, wherein the instructions, when executed by the at least one processor, cause the apparatus at least to perform:
receiving further measurements performed by the user equipment of the at least one other network, wherein the further measurements are obtained during the first network serving the user equipment; and
based on the further measurements, creating a new sharing policy or updating the sharing policy.

19. An apparatus of a second network, the apparatus comprising at least one processor and at least one memory storing instructions that, when executed by the at least one processor, cause the apparatus at least to perform:
sending, to a network node of a first network, an indication that second network has capacity for network sharing with the first network; and
receiving, from the network node of the first network, a request for network sharing with the second network, wherein the request comprises information indicative of a reason for sharing.

20. The apparatus according to claim 19, wherein the instructions, when executed by the at least one processor, cause the apparatus at least to perform:
causing the second network to serve a user equipment registered to the first network.
